(19) United States
(12) Patent Application Publication
(10) Pub. No.: US 2009/0103688 A1
(43) Pub. Date: Apr. 23, 2009

(54) System and Method For Dial Tones Screening

(76) Inventor: Gabriel Cabelli, Tel-Aviv (IL)

Correspondence Address: The Law Office of Michael E. Kondoudis, PC, 888 16th Street, N.W., Suite 800, Washington, DC, 20006, US

(21) Appl. No.: 12/298,530

(22) PCT Filed: Apr. 22, 2007
(86) PCT No.: PCT/IL07/00501

§ 371 Date: Oct. 25, 2008

Related U.S. Application Data
(60) Provisional application No. 60/794,883, filed on Apr. 26, 2006.

(51) Int. Cl. H04M 1/64

(52) U.S. Cl. 379/88.08

(57) ABSTRACT

A system and a method for screening dial tones that are transmitted by a customer's touch-tone communication device (CCD) to a destination's communication device (DCD). The system comprises a screening device (DCD). The system comprises a screening device that enables receiving and transmission of dial tones, detecting the pitch and the frequencies of each received genuine dial tone, generating of random dial tones and intersecting the random dial tones and intersecting the random dial tones through the sequence of the genuine dialed tones that are transmitted by the customer through the telephone line.

### FIELD OF THE INVENTION

The present invention generally relates to the field of electronic transmission of confidential information. More specifically, the present invention relates to the field of transmission of confidential data through touch-tone communication devices.

### BACKGROUND OF THE INVENTION

Recently, a gradually growing number of defrayment transactions are carried out through credit cards. Correspondingly, a gradually growing number of transactions are carried out through the telephone, when in many cases a customer, wishing to pay through his credit card is required to hand out his credit card number, along with the credit card's related information to a complete stranger on the other side of the telephone. Nevertheless, many customers still give out their credit cards' information to make an order delivery from vendors, to pay the bills and so on.

Some companies, authorities and vendors enable customers to make credit card transactions through automated defrayment systems that include Interactive Voice Response (IVR) based systems, where the customer types the related data such as his credit card's number, expiry date, ID and the like, through a touch-tone telephone keypad and the system automatically allows transactions such as defraying to be executed.

Unfortunately, most of the automatic defrayment systems are extremely complicated and expensive. For these reasons, the bodies that allow the use of these systems are usually financially established institutes such as banks, local authorities, big vendors and the like.

### SUMMARY OF THE INVENTION

The present invention discloses a simple and novel system and a method for screening dial tones, such as Dual Tone MultyFrequency (DTMF) tones, that are transmitted by a customer's touch-tone communication device (CCD) to a destination's communication device (DCD). The screening aims to secure the telephone line between the CCD and the DCD when the customer inputs dial tones such as DTMFs when transmitting his credit card number and other related data through the line. The system comprises a screening device that enables receiving and transmitting of dial tones, detecting the pitch and the frequencies of each received genuine dial tone, generating random dial tones and intersecting the random dial tones through the sequence of the genuine dialed tones that are transmitted by the customer through the telephone line creating a screened sequence of tones. The system may be installed, for example, at small vendors' devices, connecting the screening device to the vendor's telephone and defrayment devices.

According to some embodiments of the present invention, the screening device comprises a detector, a generator, a controller and a tone divider. The controller is a unit that enables processing and storing of data such as the DTMF tones related data, for example, the detector may detect the dial tones' pitch and frequencies. The random dial tones may be generated by the generator according to pitches calculated by the controller. The screening device may transmit the random dial tones to the DCD using the divider.

According to some embodiments of the present invention, the system may be used to secure the transmission of the customer's credit card related data when calling a destination to execute a purchase transaction, for example. The screening device may be connected to a point of sail (PS) defrayment device that enables transmission of data to a billing center to allow billing of the customer's account according to credit card data represented by the genuine dial tones, where the genuine tones are saved by the controller and may be transmitted to the PS or directly to the billing center.

The screening device may also comprise a filter that enables filtering and identifying the arriving genuine dial tones' frequencies and the transmitted random dial tones' frequencies. The filter may be connected to the divider, the controller and the detector. The filter may receive the random dial tones' frequencies data from the controller and output the genuine dial tone's frequencies to be transmitted to the billing center.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a system for tone screening, according to some embodiments of the present invention.

FIG. 2 is a schematic illustration of a screening time-chart, according to some embodiments of the present invention.

FIG. 3 is a table representing an example of touch-tone digits' DTMF frequencies.

FIG. 4 is a flowchart that schematically illustrates a method for tone screening, according to some embodiments of the present invention.

FIG. 5 is a schematic illustration of a system for tone screening, according to additional embodiments of the present invention.

FIG. 6 is a schematic illustration of a filtering mechanism, according to some embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination: Conversely, although the invention may be described herein in the context of separate embodiments for clarity, the invention may also be implemented in a single embodiment.

### DETAILED DESCRIPTIONS OF SOME EMBODIMENTS OF THE INVENTION

The present invention discloses a system and a method targeted at the protection of customers 11 against leakage of electronic classified data—such as credit card numbers and other credit card related data. A screening device device 100, receiving customer's 11 credit card number and other related data through Dual-Tone MultiFrequency (DTMF), may protect this classified information by screening the DTMFs traveling the communication telephone line I 101 between customer's communication device (CCD) 10 and the destination's communication device (DCD) 20. Line I 101 enables analogue transmission of DTMF tones and sound that may be simultaneously transmitted in both directions, as known in the art.

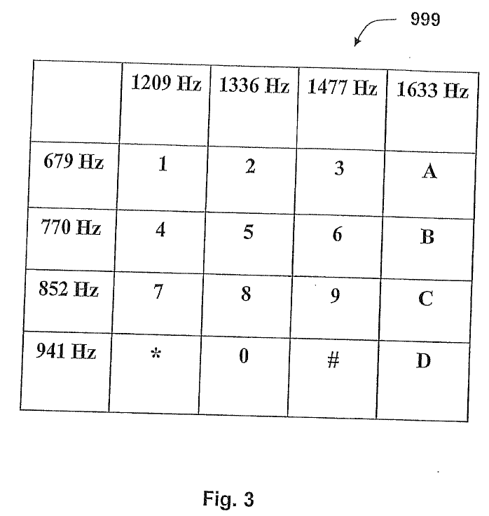

DTMF tones may represent keypad's buttons or numbers, where each number may be represented by a combination of two tone-frequencies, as illustrated in table 999 in FIG. 3. Table 999 of FIG. 3 is an example for tones frequencies representation. For example, the digit “1” is represented by the two frequencies: 679 Hz and 1209 Hz. Usually DTMFs are represented by a low frequency and a high frequency.

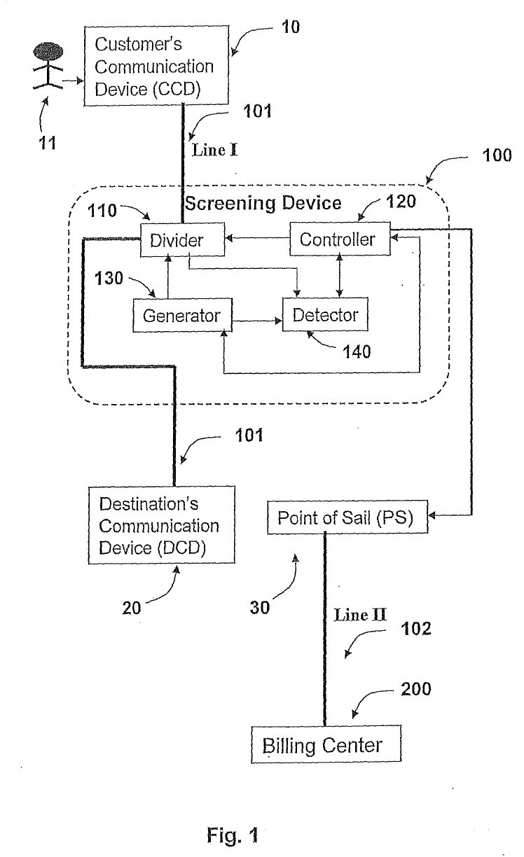

To protect line I 101, as schematically illustrated in FIG. 1, according to some embodiments of the present invention, screening device 100 may be connected to line I 101 at one input end and to the destination's point of sale (PS) system 30 and DCD 20 at the output ends. Screening device 100 may receive and transmit DTMFs as well as sound from and to the customer's communication device 10.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the sane extent as if each individual publication was specifically and individually indicated to be incorporated herein. In addition, citation or identification of any reference in the description of some embodiments of the invention shall not be construed as an admission that such reference is available as prior art to the present invention.

FIG. 1 is a schematic illustration of a system for DTMFs screening, according to some embodiments of the present invention. Customer 11 and the destination may use any type of touch-tone communication devices (10, 20) that allow transmission of DTMF tones when pressing the numbers pushbuttons on the device's keypad. Each tone is identifiable through its amplitude pitch and frequencies—associating these two tones-parameters with the corresponding digit and other related information. The system comprises client communication device (CCD) 10, screening device 100 device, destination communication device (DCD) 20 and point of sale (PS) 30 that may be a computer, a billing device or any system that allows retrieval of electronic data and communication with a billing center 200. Screening device 100 may be connected to the telephone line I 101 that connects customer's 11 and destination's devices 10 and 20, as illustrated in FIG. 1. Billing center 200 may be any computerized unit that enables receiving of clients' 11 related electronic data such as credit card numbers, cards' expiry dates, customer's identification number (ID), billing sums and the like or the receiving of coded data and decoding and translating it to the said clients' 11 data. Billing center 200 may be, for example, the credit card company's computer or a bank's computer enabling billing of the client's 11 account according to information extracted from client's 11 data.

According to some embodiments of the present invention, as illustrated in FIG. 1, screening device 100 may be a device that comprises a divider 110, a controller 120, a detector 140 and a generator 130. Divider 110 enables splitting the tones signals arriving from and transmitted to line I 101. Detector 140 enables detections of tone-parameters such as, for example, the tone's amplitude pitches, frequencies and the like. Generator 130 may generate random DTMF tones. Those random tones may be inter-combined with the original received tones, in different time-intervals (TI) to produce a “screened sequence”, which is the “genuine sequence” of DTMF tones combined with the random DTMF tones generated by generator 130. Controller 120 may be a processing unit that may comprise a memory unit to enable receiving the genuine tones as well as the random tones from detector 140, processing and storing the detected data and other related information. For example, controller 120 may store data related to each DTMF tone and its amplitude pitch and frequencies. Controller 120 may store the position of the tone in the screened sequence and the “tone's status”—meaning if the tone is a genuine tone or a generated random tone.

According to embodiments of the present invention, screening device 100 may enable the screening by detecting the “dialing mechanism” of customer 11. The dialing mechanism may be defined as a statistical evaluation that samples the first few tones, dialed by customer 11, where the number of tones is a predefined “N” number of the first genuine dialed DTMF tones. The statistical evaluation receives the time intervals between the pressing of the dial buttons of customer 11 and the dialing amplitude pitch, which may indicate customer's CCD's 10 imprint and/or the intensity at which customer 11 pushes the dialing buttons. Controller 120 may receive the time intervals and pitches parameters from detector 140. Alternatively, controller 120 may receive the pitches and frequencies from detector 140 and may measure the time intervals by itself. Once the genuine time intervals (TIs) and pitches of the first “N” tones have been detected and stored—controller 120 may apply a mathematical calculation to determine an insertion time interval “TIᵢₙₛ” and an average pitch “Pₐᵥ”, which may be defined as the parameters that represent customer's 11 dialing behavior. “TIᵢₙₛ” may be calculated as the average time interval between each two genuine DTMF tones of the first “N” genuine DTMF tones. Controller 120 may control the generation of random DTMF tones by generator 130. Generation of random DTMF tones may be carried out according to tie calculated parameters—meaning that the tones may be inputted in time intervals of the “TIᵢₙₛ” and the pitches of “Pₐᵥ”.

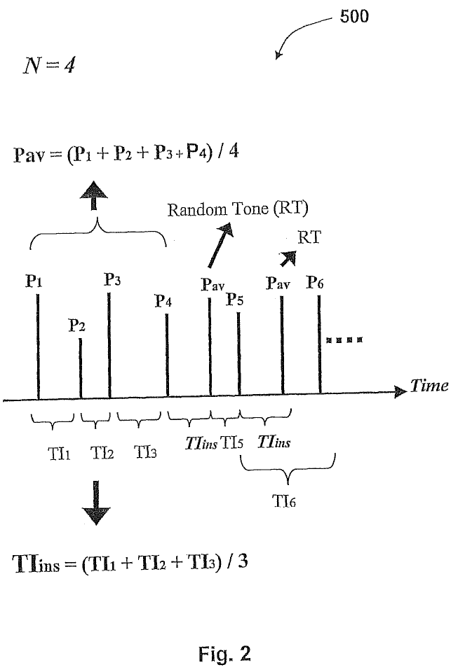

FIG. 2 is a schematic illustration of a screening time-chart 500, according to some embodiments of the present invention. According to the example illustrated in FIG. 2, screening device 100 screens the genuine DTMF sequence of a credit card. The first four numbers that are dialed by customer 11 may be used for the calculation of the average TIᵢₙₛ and the average tone pitch Pₐᵥ. Generator 130 may generate random tones that have the average pitch placed within the dialing average time intervals. According to this mechanism, from the “N^{th}” DTMF and on, controller 120 may insert a random DTMF tone transmitting this random tone back to customer 11 through line I 101. Since controller 120 controls the generation of random tones—through generator 130 according to the mathematical calculations and the detection of the genuine tones—controller 120 enables storing only the genuine tones' data and transmit this data to billing center 200 through PS 30.

According to some embodiments of the present invention, the time interval that may be used for inserting the random DTMF tones “TIᵢₙₛ” may be the smallest time interval sampled at the firs “N” genuine DTMF tones or the smallest TI enabled by the system, instead of using an average TI. Each random DTMF tone transmitted to CCD 10 must avoid overriding the incoming genuine DTMF tones. Therefore, the insertion of the random DTMF tones as fast as possible by the system right after receiving each genuine DTMF tone may be determined by the smallest detected TI and/or by the system's timing limitations.

According to some embodiments of the present invention, divider 110 may receive, divide and switch the transmission of sound and DTMF tones through line I 101. To facilitate a safe transmission of random DTMF tones to CCD 10 and receiving of genuine DTMF tones from CCD 10—divider 110 may enable blocking the transmission of sound to CCD 10 once detector 140 detects any type of DTMF tones. Controller 120 may control divider 110, where divider 110 may comprise at least one switch, to enable the blockage of sound transmission. Sound transmission received through line I 101 enables conversation between customer 11 and the destination, therefore once divider 110 switches the sound transmission off—the person on the destination side of line I 101 may not be able to talk to customer 11 and/or vice versa, once customer 11 presses the credit card related digits.

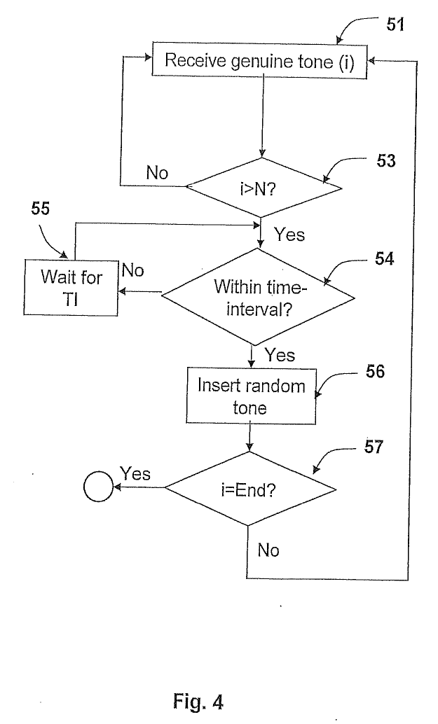

FIG. 4 is a flowchart that schematically illustrates a method for DTMF tone screening, according to some embodiments of the present invention. The method comprises the steps of:
receiving a genuine DTMF tone (i) 51—where detector 140 detects an i genuine DTMF tone's parameters, such as time, pitch and frequencies, and transmits this data to controller 120;
the first “N” detected genuine tones may be used for the mathematical calculations 53 that may determine the TI and pitch of the random DTMF tones;
inserting a random DTMF tone 56—where each random tone may be transmitted only within the preset TIᵢₙₛ 54; a random DTMF tone may be generated by generator 130 and transmitted to CCD 10 through line I 101 through divider 110;
Once a DTMF representing an end dial tone is detected 57—for example a DTMF that represents “#” button—the system may end the process;

According to embodiments of the present invention and the system's definitions, the process illustrated in FIG. 4 may automatically repeat for each “data type session”, where said session relates to the type of data inputted by customer 11. For example, the first data type session may be the typing of the credit card number, where the digit “#” represent the end of this session; the second data type session may be the typing of the credit card expiry date, where the digit “#” represent the end of this session; the third data type session may be the typing of the customer's 11 ID number, where the digit “#” represent the end of this session; and so forth. The system may be preset to anticipate the number of genuine DTMF tones it should receive according to the data type session and according to the preset order of the sessions.

According to embodiments of the present invention, the system may further comprise an Interactive Voice Response (IVR) device, which is an automated real-time telephone information system that enables transmission of prerecorded voice messages upon receiving DTMF tones. Screening device 100 may include an IVR system that may enable automatic response to receiving the genuine DTMF tones. For example, the IVR may transmit the message “Enter your credit card number and then #”; upon receiving the card number and the end digit the system may transmit a verification message and then the same message requesting the expiry date of the card —and so forth. Once a system such as the IVR system is installed within screening device 100, the entire process of customer 11 executing a transaction with a destination such as a vendor, a service center and the like, may be carried out automatically with no vendor or any other person responding at the DCD 20.

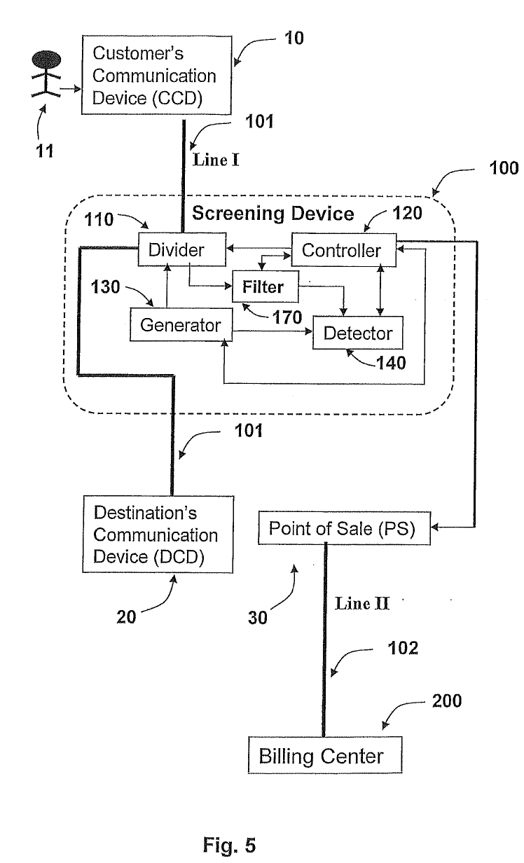

According to additional or alternative embodiments of the present invention, screening device 100 may further comprise a filter 170, as illustrated in FIG. 5. Filter 170 may facilitate in transmitting the generated random DTMF tones regardless of the arrival time of the genuine DTMF tones. Filter 170 may enable identifying a digital superposition of at least four DTMF tones that travel line I 101 within the same time interval, where the superposition may be preset according to the system's definitions and controlled by controller 120. Filter 170 may eliminate the need to detect each arriving genuine DTMF tone prior to transmitting a random DTMF tone.

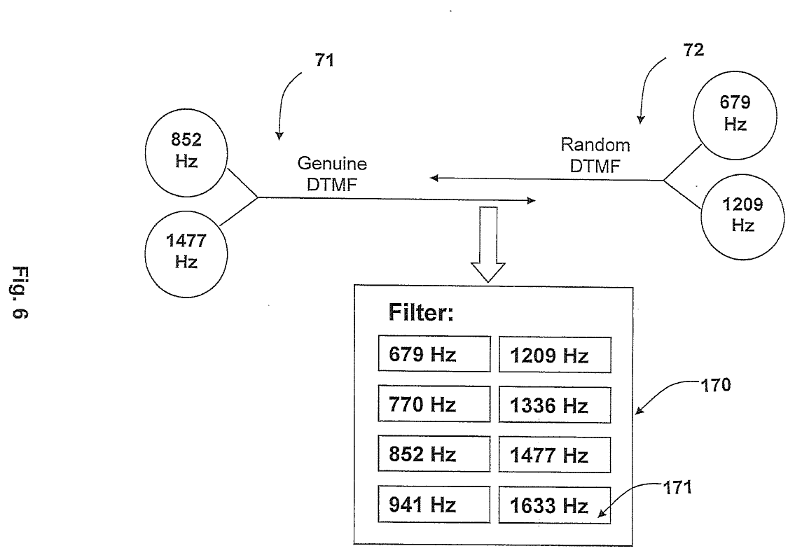

FIG. 6 schematically illustrates a random DTMF and a genuine DTMF passing through the same line I 101 approximately within the same time interval. Divider 110 may enable filter 170 to receive the superposition of those tones. Since each DTMF is composed of two substantially distinct frequencies, the total superposition may still enable distinction between each frequency. Filter 170 may be combined, for example, of band pass filters (BPF) 171 one for each frequency out of the frequencies range defined for the telephone digits. Each BPF 171 may identify one frequency, as illustrated in FIG. 6, where eventually filter 170 may receive the superposition of genuine plus random DTMF tones, the random DTMF's frequencies data as an input from controller 120, and output the genuine frequencies. For example, customer 11 transmits a genuine DTMF representing the number “1” that is combined of the frequencies: 679 Hz and 1209 Hz (see above table); generator 130 generates the random number “6” that is combined of the frequencies: 770 Hz and 1447 Hz; filter 170 receives those four frequencies and the data from controller 120 that the random frequencies are 770 Hz and 1447 Hz and so filter 170 enables identifying that the genuine frequencies are the two remaining frequencies.

According to some embodiments of the present invention, controller 120 may transmit data such as credit cart related data to PS 30 or directly to billing center 200 through network line II 102, using any communication network and security mechanisms known in the art.

According to some embodiments of the present invention, the system may comprise an automated voice identification system (AVIS) to allow identification of the credit card's owner. The AVIS may retrieve prerecorded voices of credit cards' owners and compare the real time voice of the owner with the recorded voice. The comparison may facilitate in preventing false transactions and securing the transmission of the customer's credit card related data to the DCD 20 and the PS 30.

To enable the comparison between the caller's voice and the prerecorded voice, the system may request the caller to say the same words as the ones prerecorded by the AVIS. For example, the prerecorded voice may comprise the owner's full name. The system may request the caller to pronounce the name of the card's owner in order to compare the voices and verify that the owner of the caller is the card's owner. The request may be carried out by a prerecorded message using, for example, an Interactive Voice Response (IVR) system.

According to embodiments of the present invention, the system may send a notification message to CCD 10 and/or to any other communication devices that have been predefined by the system. The sending of the notification message may be carried out through any method known in the art that is available in the communication devices such as, for example, Short Messages Service (SMS), Multimedia Messaging Service (MMS) and the like.

The communication devices that are predefined by the system may be stored at least in one database. The database may be stored by at PS 30 and/or at billing center 200. The notification message may comprise verification to the transaction. For example, the notification message may comprise the validation number and the details of the transaction. The transaction's details may be, for example, the sum of money, the number of payments, the date and hour of the transaction, etc.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system for screening genuine dial tones that are transmitted by a customer's touch-tone communication device (CCD) to a destination's communication device (DCD) through a telephone line, said system includes a screening device that is connected to the DCD, said screening device comprises:
a detector that enables, detecting the pitch, the frequencies of dial tones and the time intervals between dial tones;
a generator that enables generating of random dial tones;
a divider that enables dividing, receiving and transmitting of dial tones from and to the telephone line;
a controller that enables processing and storing of data;
wherein the screening device enables intersecting the random dial tones with the sequence of the genuine dialed tones transmitted from the CCD, while the customer inputs at least some of the dial tones.

2. The system of claim 1, where the dial tones are DTMF tones.

3. The system of claim 2 wherein the genuine tones that are saved by the controller are transmitted to a point of sale defrayment device.

4. The system of claim 3, wherein the point of sail device enables transmission of data to a billing center to allow billing of the customer's account according to credit card data represented by the genuine tones.

5. The system of claim 1 wherein the genuine tones that are saved by the controller are transmitted directly to the billing center.

6. The system of claim 1, wherein the screening device further comprises a filter that enables filtering and identifying the arriving genuine dial tones' frequencies and the transmitted random dial tones' frequencies.

7. The system of claim 6, wherein the filter is connected to the divider, the controller and the detector and receives the random dial tones' frequencies data from the controller and outputs the genuine dial tone's frequencies.

8. The system the of claim 1, wherein the divider blocks the transmission ability of sound through the telephone line once a transmission of dial tones is detected.

9. The system of claim 1 wherein at least some of the genuine dial tones represent a credit card number.

10. The system of claim 9 further comprises an automated voice identification system (AVIS) that allows comparing a caller's voice with a prerecorded voice, wherein said AVIS enables verifying the identity of the caller.

11. The system of claim 9 enables sending of notification messages to at least one communication device that has been predefined by the system.

12. The system of claim 11, wherein the notification message comprises transaction related data.

13. A method for screening of genuine dial tones transmitted by a touch-tone customer's communication device (CCD) to a destination's communication device (DCD) through a telephone line, said method comprises the steps of:
receiving genuine dial tones from the CCD and detecting said tone's amplitude pitch and the time intervals between the arriving genuine tones;
generating random tones and transmitting said random tones from the CCD to the DCD through the same telephone line while some of the genuine tones are still transmitted to DCD;
wherein the random tones are transmitted to the CCD through the telephone line in predetermined time intervals that intercross the time intervals of the arriving genuine tones.

14. The method of claim 13, wherein the screening of dial tones is carried out by a screening device connected to the telephone line.

15. The method of claim 14, wherein the screening device detects the arriving genuine tones, generates random tones and intersects the random dial tones through the sequence of the genuine dialed tones, while the customer inputs at least some of the genuine dial tones using the CCD.

16. The method of claim 14, wherein the genuine tones represent credit card related data and the screening device enables saving the genuine tones and transmitting said tones to a billing center that allows billing the customer's account according to data transmitted through said genuine tones.

17. The method of claim 16, wherein the billing center receives the credit card related data through a point of sail (PS) device installed at the destination and said PS receives the genuine tones from the screening device.

18. The method of claim 13, wherein the random tones' predetermined time interval intercrossing the time intervals of the arriving genuine tones is calculated average time interval between a predetermined number of first detected genuine tones.

19. The method of claim 13, wherein the random tones' predetermined time interval intercrossing the time intervals of the arriving genuine tones is the smallest detected time interval of the first predetermined number of genuine tones.

20. The method of claim 13, wherein the random tones' pitch is the calculated average pitch of a predetermined number of first genuine tones.
